(19) United States
(12) Patent Application Publication
(10) Pub. No.: US 2025/0342571 A1
(43) Pub. Date: Nov. 6, 2025

(54) ACCUMULATED NOISE MODEL FOR OPTIMAL NOISE REDUCTION OPERATIONS

(71) Applicant: QUALCOMM Incorporated, San Diego, CA (US)

(72) Inventors: Victor Pinto, Zichron Yaakov (IL); Mark Gintsburg, Haifa (IL); Nir Strauss, Yokneam Moshava (IL)

(21) Appl. No.: 18/655,908

(22) Filed: May 6, 2024

(51) Int. Cl. G06T 5/70

(52) U.S. Cl. CPC G06T 5/70; G06T 2207/20024

(57) ABSTRACT

This disclosure provides systems, methods, and devices for image signal processing that support improved noise reduction. In a first aspect, a method of image processing includes receiving an input image frame captured by an image sensor; receiving a value map corresponding to the input image frame; processing the input image frame to determine a processed image frame, wherein the processing comprises determining an updated value map based on the processing of the input image frame; and applying a noise reduction filter to the processed image frame based on the updated value map, wherein a strength of the noise reduction filter applied to each pixel of the input image frame is based on a corresponding value of the updated value map. Other aspects and features are also claimed and described.

### TECHNICAL FIELD

Aspects of the present disclosure relate generally to image processing, and more particularly, to noise reduction during image processing. Some features may enable and provide improved image processing, including improved noise reduction for each stage of an image processing pipeline.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user. The higher resolution images produce higher resolution, better image quality, and thus better user experiences.

Noise reduction also improves the image quality of photographs and videos. For example, the image data may be processed through several processing blocks for enhancing an image before it is displayed to a user on a display or transmitted to a recipient in a message. If excessive noise filtration is applied to the processed image data, fine details in parts of the image may be lost. On the other hand, if the level of noise reduction applied to the image data is insufficient, the final output image may have excessive noise artifacts that degrade the image quality.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One cause for poor image quality of snapshots and video produced by image capture devices is suboptimal noise filtration due to inaccurate noise level estimates during image processing. Noise levels are typically measured for only a finite number of points within an image frame, and the measurements performed at a laboratory on the image sensor. Noise levels are thus not available during operation for every operating condition. Therefore, linear interpolation is often used to estimate the level of noise and filtration for pixels falling between these measured points. This interpolation leads to inaccuracies in noise estimates, which can result in applying excessive noise filtration to pixels of the image frame such that fine details are lost in certain regions of the image frame while insufficient noise filtration causes excessive noise artifacts that degrade image quality in other regions.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

In some aspects of the present disclosure, an accumulated noise model may be used to improve noise reduction filtering for each pixel or group of neighboring pixels of an image frame as it is processed through different stages of an image processing pipeline. The accumulated noise model may be represented by a gain map that is at the same resolution as the image frame or a lower resolution as the image frame. In this description, when “each pixel” is referred to, the image processing techniques being described should be considered as also applying to groups of pixels when a representative pixel is used (such as when a lower representation of an image frame is used for a portion of the image processing). The image processing pipeline may include a sequence of processing stages with multiple types of operations that impact the noise levels of pixels in different areas of the image frame after it has been captured by an image sensor of an image capture device. Examples of operations in the image processing pipeline include, but are not limited to, linear operations (such as gain, black level subtraction, and white balance), radial operations (such as chromatic aberration correction and lens shading correction), and non-linear operations (such as combining multiple exposures, temporal filtering, local tone mapping (LTM), instance semantic segmentation, and convolution operations like warping, scaling, and demosaic). The particular operations that are performed during image processing may vary according to the sensor modes supported by the image capture device and/or image sensor thereof.

To improve the noise reduction filtering applied to the processed image frame, a value map may be used to calibrate a strength of the noise reduction filter applied to each pixel or grouping of neighboring pixels of the image frame based on the operations performed at each stage of the image processing pipeline. The value map may be, for example, a noise map that includes a value characterizing an accumulated noise variance per channel for each pixel of the image frame. Alternatively, the value map may be expressed as a gain map in which the value for each pixel characterizes the accumulated noise variance as a function of gain. The value map may be passed with the image frame between the different processing stages of the pipeline. Appropriate values within the value map may be updated based on the operations performed at each processing stage and particularly, based on whether any of those operations impact a pixel's gain and/or noise level. For example, when operations performed during a stage of the pipeline cause the gain and/or noise values of pixels in the image frame to be adjusted, corresponding values in the value map may be appropriately adjusted according to the adjusted values of the image frame. If, however, no operations affecting a pixel's gain and/or noise level are performed during the stage, no values are adjusted and the value map is passed as is to the next processing stage. Accordingly, the values in the value map may be used to appropriately calibrate noise reduction and filtration settings for corresponding pixels within different parts of an image frame based on the operations performed during various stages of the image processing pipeline, e.g., for a particular sensor mode supported by the image capture device.

The use of a value map during image processing may provide an accurate noise model that enables noise reduction operations to be performed during image processing based on the actual noise levels of pixels in different areas of an image frame without the need for interpolation. An accurate noise model allows optimal decision thresholds to be set in the noise reduction filters to prevent loss of image details and/or excessive noise residue that degrades image quality. Additionally, the use of such a noise model enables the calibration or tuning of noise reduction elements in the image processing pipeline, e.g., as implemented by an image signal processor (ISP) of the image capture device, to be simplified because targets set for the level of noise, detail, texture, and resolution may be used to determine the final image output by the pipeline. The calibration of the image processing pipeline can also be cumulative and deterministic for operations associated with the different sensor modes supported by the image capture device and/or image sensor thereof. Furthermore, filters in the pipeline may be calibrated using back-propagation techniques to support the level of noise reduction needed to meet the targets set for the final output image, e.g., as defined by a user (e.g., a tuning engineer) during an ISP calibration procedure.

In one aspect of the disclosure, a method for image processing includes receiving an input image frame captured by an image sensor, receiving a value map corresponding to the input image frame, processing the input image frame to determine a processed image frame, wherein the processing comprises determining an updated value map based on the processing of the input image frame, and applying a noise reduction filter to the processed image frame based on the updated value map, wherein a strength of the noise reduction filter applied to each pixel of the input image frame is based on a corresponding value of the updated value map.

In an additional aspect of the disclosure, an apparatus includes at least one processor and a memory coupled to the at least one processor. The at least one processor is configured to perform operations including receiving an input image frame captured by an image sensor, receiving a value map corresponding to the input image frame, processing the input image frame to determine a processed image frame, wherein the processing comprises determining an updated value map based on the processing of the input image frame, and applying a noise reduction filter to the processed image frame based on the updated value map, wherein a strength of the noise reduction filter applied to each pixel of the input image frame is based on a corresponding value of the updated value map.

In an additional aspect of the disclosure, an apparatus includes means for receiving an input image frame captured by an image sensor, means for receiving a value map corresponding to the input image frame, means for processing the input image frame to determine a processed image frame, wherein the processing comprises determining an updated value map based on the processing of the input image frame, and means for applying a noise reduction filter to the processed image frame based on the updated value map, wherein a strength of the noise reduction filter applied to each pixel of the input image frame is based on a corresponding value of the updated value map.

In an additional aspect of the disclosure, a non-transitory computer-readable medium stores instructions that, when executed by a processor, cause the processor to perform operations. The operations include receiving an input image frame captured by an image sensor, receiving a value map corresponding to the input image frame, processing the input image frame to determine a processed image frame, wherein the processing comprises determining an updated value map based on the processing of the input image frame, and applying a noise reduction filter to the processed image frame based on the updated value map, wherein a strength of the noise reduction filter applied to each pixel of the input image frame is based on a corresponding value of the updated value map.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals may include a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to some embodiments of the disclosure.

FIG. 3 shows a flow chart of an example method for locally adjusting noise filtration thresholds to optimize noise reduction during image processing according to some embodiments of the disclosure.

FIG. 4 is a chart illustrating an example of using linear interpolation to calibrate noise filtration thresholds or a strength of a noise reduction filter for different pixels of an image frame.

FIG. 5 is a diagram illustrating an example of calibrating noise reduction filter strength using a value map in the form of a noise map that characterizes an accumulated noise variance for each pixel of an input image frame processed over different stages of an image processing pipeline according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for processing an image frame over different stages of an image processing pipeline using an accumulated noise model that optimizes noise reduction in the processed image frame. The accumulated noise model may provide a more accurate representation of noise levels for different pixels in the image frame relative to conventional approaches that use a worst-case noise model to manually tune noise reduction filter settings. As will be described in further detail below, the disclosed noise reduction techniques may enable improved noise filtration thresholds to be set for the processed image frame based on the operations performed during different stages of the image processing pipeline.

Particular implementations of the subject matter described in this disclosure may be implemented to realize one or more of the following potential advantages or benefits. In some aspects, the present disclosure provides techniques for improving noise reduction filtering using an accumulated noise model in the form of a value map that is adjusted based on image processing operations affecting the noise levels associated with pixels of an image frame. The noise filtration thresholds for those pixels may be more accurately determined to prevent loss of image detail and/or excessive noise artifacts that degrade image quality.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device, such as a smartphone, for capturing image frames using one or more image sensors may include a configuration of one, two, three, four, or more camera modules on a backside (e.g., a side opposite a primary user display) and/or a front side (e.g., a same side as a primary user display) of the device. The device may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

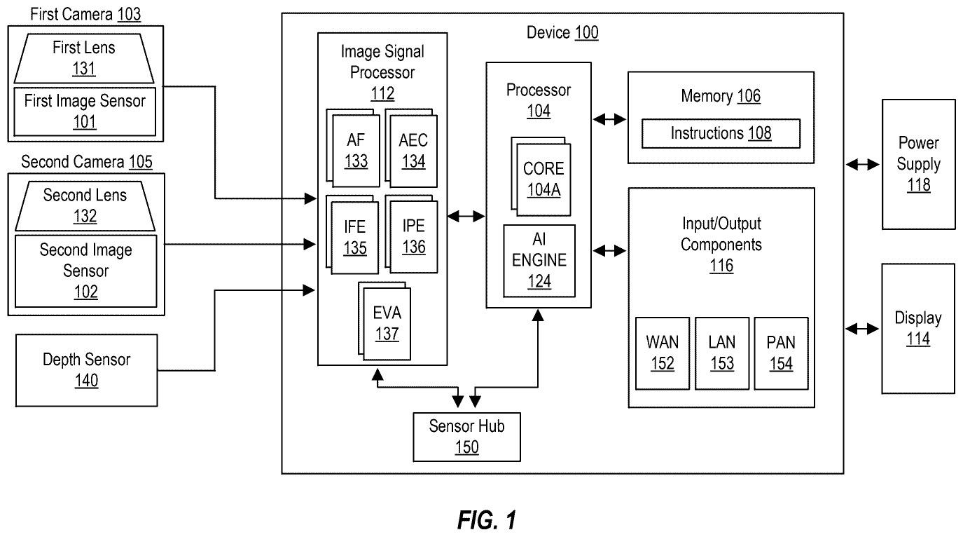

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that an ultra-wide (UW) camera has a larger FOV than a wide (W) camera, which has a larger FOV than a telephoto (T) camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image processing pipeline of the ISP 112 may be formed by a sequence of one or more of the IFE 135, IPE 136, and/or EVA 137. In some embodiments, the image processing pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or the second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including operations for processing image data with an accumulated noise model to optimize noise reduction. For example, execution of the instructions can instruct the ISP 112 to begin or end capturing an image frame or a sequence of image frames, in which the capture includes a value map that can be used to calibrate the noise reduction or filtration applied to corresponding pixels of each image frame over different stages of image processing as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of a noise reduction filter to the pixels of each image frame. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. For example, the ANN may be trained to estimate noise levels from various features, such as texture, color, and brightness variations, of each image frame being processed over different stages of the image processing pipeline. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

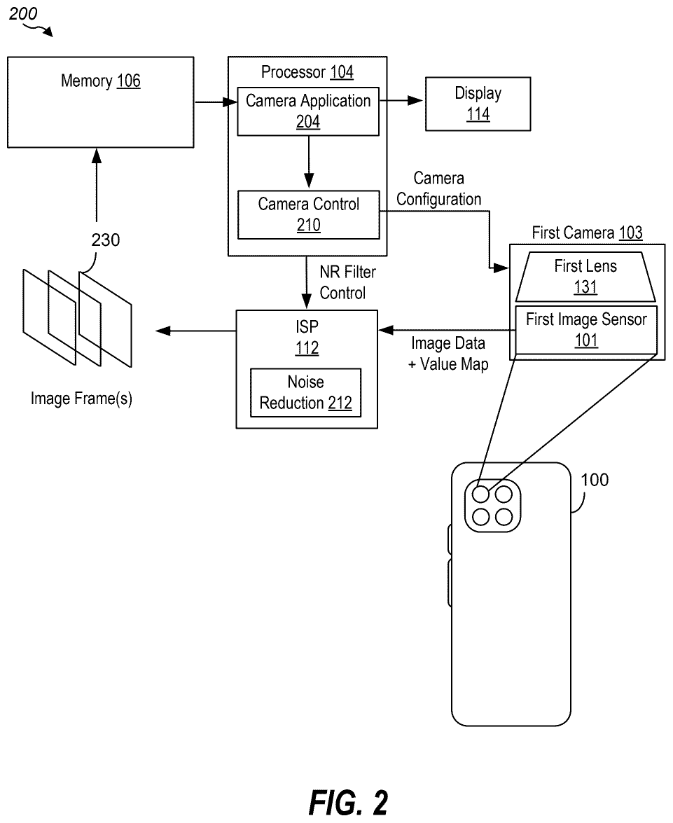

The exemplary image capture device of FIG. 1 may be operated to obtain improved images by using a noise variance map to locally adjust noise filtration thresholds for spatial and temporal noise reduction operations to preserve details and reduce noise during image processing. One example method of operating an image capture device to obtain improved images captured by one or more cameras, such as first camera 103 and/or second camera 105, is shown in FIG. 2 and described below.

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some embodiments, the effects may be applied in the ISP 112.

The output image frames 230 produced by the ISP 112 may include representations of the scene improved by aspects of this disclosure, such that important details within the captured scene are retained while unwanted noise is reduced. The processor 104 may display these output image frames 230 to a user, and the improvements provided by the described processing implemented in the ISP 112 and/or processor 104 improve the image quality and the user experience by locally adjusting noise filtration thresholds to preserve details and reduce noise in different regions of each output image frame.

For example, a noise reduction (NR) module 212 in the ISP 112 may use a value map received with the image data from the first camera 103 to adjust a strength of a NR filter applied to the image data when determining the output image frames 230. The value map may represent an accumulated noise model that characterizes an accumulated noise variance for each pixel of an input image frame included in the image data captured by the first image sensor 101. A different noise model or value map may be used to characterize the accumulated noise variance for each operating mode of the first image sensor 101. The NR module 212 in this example may be configured by an NR filter control signal received by the ISP 112 from the processor 104 and/or the first camera 103. The control signal may trigger operation of the NR module 212 to detect that the first image sensor 101 is configured for a particular mode of operation and to adjust the strength of the NR filter applied to each pixel of the input image frame based on the accumulated noise variance indicated by the value map for that particular mode. The NR filter control signal may also trigger the NR module 212 to adjust the NR filtration strength and/or calibrate filtration thresholds based on user preferences for individual camera settings, e.g., in addition to or in the alternative to the default settings associated with a current configuration of the first image sensor 101. Such preferences or settings may be specified by a user via, for example, an interface of the camera application 204, as described above.

In some embodiments, the noise reduction operations associated with the NR module 212 may be performed as part of a noise reduction stage of an image processing pipeline of the ISP 112. The noise reduction stage may be one of a plurality of processing stages in the pipeline for processing the image data. As the image data is processed over the plurality of stages of the ISP 112 and pixel values are adjusted based on the processing operations performed at each stage, corresponding values in the value map may be adjusted accordingly. For example, the processing operations performed at a first stage of the pipeline may include white balance operations in which pixel values are adjusted to correct colors in an image so that objects that are physically white appear white in the image. The pixel values may be adjusted across the red, green, and blue (RGB) channels, e.g., by adjusting a gain or multiplier applied to one or more of these channels. As adjusting (e.g., by increasing) the gain in a channel may amplify the noise in that channel, corresponding values of the value map may be adjusted to model the accumulated noise variance of the pixels for that channel. The accumulated noise variance per channel for each pixel represented by the value map may later be used by the NR module 212 to appropriately adjust the NR filter strength applied to that pixel and compensate for any additional noise in a particular channel (e.g., due to white balance or other operations) when determining the output image frames 230.

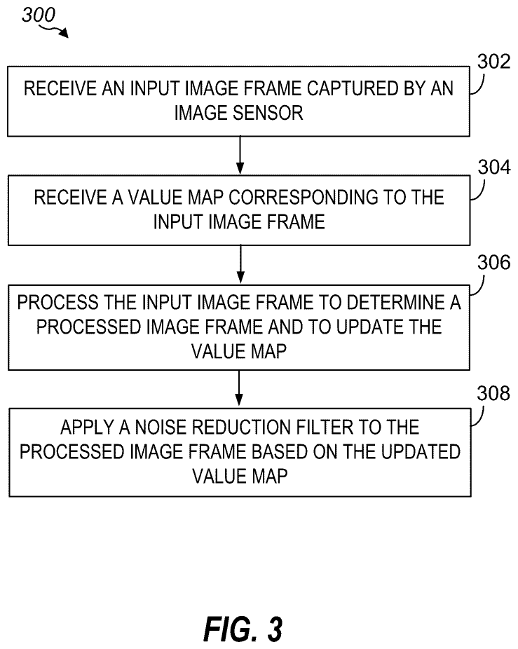

The system 200 of FIG. 2 may be configured to perform the operations described with reference to FIG. 3 to determine output image frames 230. FIG. 3 shows a flow chart of an example method 300 for locally adjusting noise filtration thresholds to optimize noise reduction during image processing according to some embodiments of the disclosure. Each of the operations described with reference to FIG. 3 may be performed by one or a combination of the processor 104 (including cores 104A-N and/or AI engine 124) and/or the ISP 112 (including the NR module 212).

At block 302, an input image frame captured by an image sensor of an image capture device (e.g., the first image sensor 101 of the system 200 shown in FIG. 2) is received, such as while the image sensor is configured for operation in a first mode of operation (e.g., as specified by a user via the camera application 204 of the system 200). The first mode of operation may be one of a plurality of operating modes supported by the image sensor. Each of the operating modes may vary at least one of a resolution, a frame rate, or a gain setting of the image sensor used to capture the input image frame. Examples of operating modes supported by the sensor may include, but are not limited to, high-definition (HD) or 720p image resolution (1,280×720 pixels), full HD or 1080p image resolution (1,920×1,080 pixels), ultra HD, 4K image resolution (3,840×2,160 pixels), 8K image resolution (7,680×4,320 pixels), high frame rate, low gain, high gain, etc.

The input image frame at block 302 may be included within, for example, image data received by the ISP 112 of the system 200 via a bus coupled to the first camera 103 or from an analog front end (AFE) coupled to the first camera 103, as described above. The input image frame may alternatively be received from a wireless camera, in which the input image frame is received through one or more of the WAN adaptor 152, the LAN adaptor 153, and/or the PAN adaptor 154. The input image frame may alternatively be received from a memory location or a network storage location, such as when the input image frame was previously captured and is now retrieved from memory 106 and/or a remote location through one or more of the WAN adaptor 152, the LAN adaptor 153, and/or the PAN adaptor 154. In some embodiments, the capture of input image frame may be initiated by the camera application 204 executing on the processor 104, which causes camera control 210 to activate capture of the input image frame along with other image data (e.g., additional input image frames for a video of a scene) captured by the first camera 103. The input image frame received at block 302 may then be processed by the ISP 112 and/or processor 104 or other means for processing image data according to the operations described with respect to one or more of the following blocks.

At block 304, a value map corresponding to the input image frame is received. In some embodiments, the value map may be received with the input image frame from the image sensor. Alternatively, the value map may be received from a memory location or a network storage location, as described above. In some embodiments, the value map may be a noise map characterizing a noise level for each pixel or group of neighboring pixels of the image sensor and/or corresponding pixel of the input image frame captured by the sensor. The noise level for each pixel may be expressed by a value representing the variance and/or standard deviation of pixel values within a specified neighborhood or window around that pixel. In some implementations, the noise map may be, for example, a two-dimensional (2D) array that characterizes, for each value in the noise map or 2D array, an accumulated noise variance for a corresponding pixel of the image sensor and/or the input image frame. In some embodiments, the noise map may be used to characterize the pixel noise levels associated with an operating mode of the image sensor used to capture the input image frame, as described above.

At block 306, the input image frame is processed to determine a processed image frame. In some embodiments, the input image frame may be processed over a plurality of processing stages. The processing stages may correspond to, for example, different stages of an image processing pipeline associated with an image signal processor (e.g., the ISP 112 of the device 100 in FIG. 2 or the system 200 in FIG. 2, as described above). As described above, the image processing pipeline may include a sequence of processing stages with multiple types of operations that impact pixel noise levels in different areas of the input image frame after it has been captured by the image sensor. Examples of such operations include, but are not limited to, gain operations, channel-dependent white balance, local tone mapping, and convolution operations such as warping, scaling, and demosaic. In some implementations, the particular operations and processing stages that are performed as part of the image processing pipeline may vary according to the particular sensor mode used to capture the input image frame at block 302. As the input image frame is processed to determine the process image frame, the processing may include updating the value map to determine an updated value map (also referred to as an “aggregated value map” or “aggregated noise map” or “aggregated gain map”).

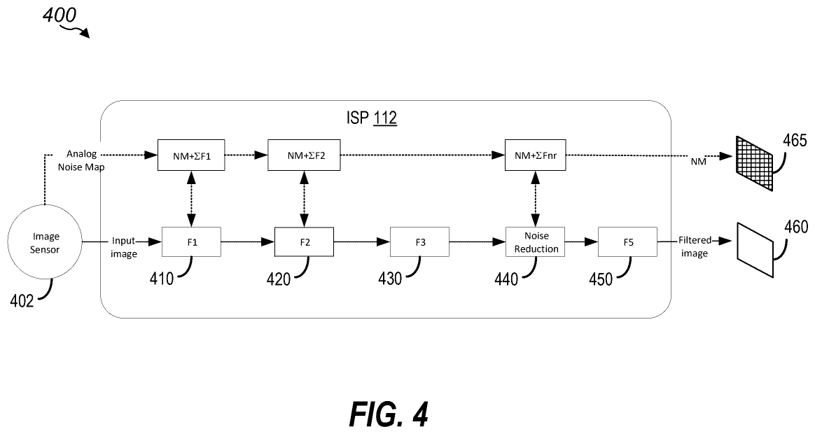

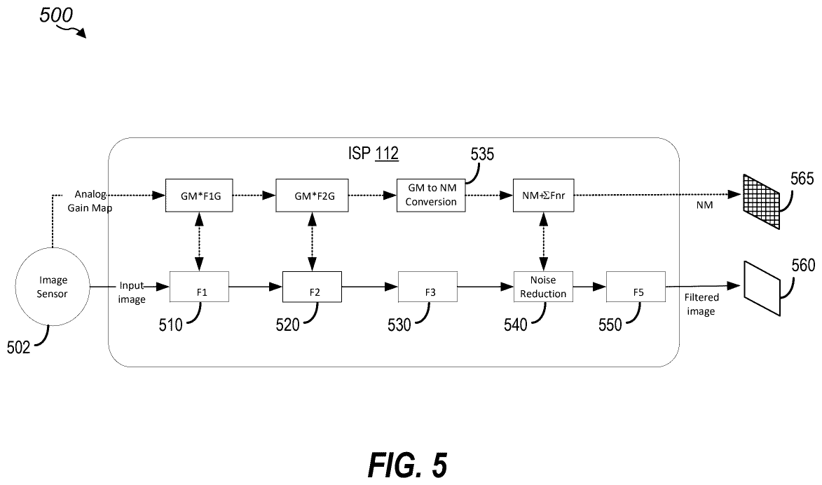

At block 308, a noise reduction filter may be applied to the processed image frame determined at block 306 based on the updated value map of block 306 and/or based on the value map received at block 304. As described above, the value map may include a value that characterizes an accumulated noise variance for each pixel of the input image frame. Accordingly, a strength of the noise reduction filter applied to each pixel of the input image frame at block 308 may be based on a corresponding value of the value map. In some embodiments, the value map received at block 304 may be updated during the processing of the input image frame at block 306. For example, values of the value map corresponding to pixels in different areas of the input image frame may be updated as the accumulated noise variance for each pixel in these areas changes over one or more processing stages of the image processing pipeline. As pixel values of the input image frame are adjusted when determining the processed image frame at block 306, corresponding values of the value map may be adjusted accordingly. As will be described in further detail below with reference to FIG. 4 and FIG. 5, the use of such an accumulated noise variance map during image processing enables an image signal processor or a noise reduction module thereof (e.g., NR module 212 of ISP 112 in FIG. 2) to locally adjust or calibrate noise filtration thresholds for optimal noise reduction without the need for interpolation.

The disclosed noise reduction techniques may be used to improve noise reduction filtering during image processing by locally adjusting or calibrating the level of noise filtration applied to each pixel or group of neighboring pixels of a processed image frame. As described above, a value map representing an accumulated noise model may be used to provide an accurate estimate of noise levels within different areas of the image frame and set appropriate filtration thresholds the image to preserve image quality and prevent loss of detail in these areas of the image frame. As will be described in further detail below with reference to FIG. 4 and FIG. 5, the value map may be updated based on processing operations affecting the noise and/or gain levels of pixels in the image frame as it is processed over different stages of an image processing pipeline associated with an image signal processor (e.g., the ISP 112, as described above with reference to FIGS. 1 and 2).

FIG. 4 is a diagram illustrating an example of calibrating noise reduction filter strength using a value map in the form of a noise map that characterizes an accumulated noise variance for each pixel of an input image (or image frame) processed over different stages of an image processing pipeline 400 according to some embodiments of the disclosure. As shown in FIG. 4, the pipeline 400 may include processing stages 410, 420, 430, 440, and 450 for processing the input image received from an image sensor 402 (e.g., the first image sensor 101 of FIG. 2, as described above). Each processing stage of the pipeline 400 in this example may represent a different filter (e.g., F1, F2, F3, etc.) applied to the input image, where each filter may be designed to achieve a specific task in the process of converting raw sensor data into a final, visually-appealing filtered image 460. Processing stage 440 may correspond to a noise reduction stage of the pipeline 400 in which noise reduction operations are performed on the input image (e.g., by applying a noise reduction filter (Fnr) to each pixel of the input image) after being processed at processing stages 410, 420, and 430. An additional processing stage 450 (e.g., an image compression stage for compressing the processed image into a format suitable for storage or transmission) may be performed after the noise reduction stage 440. Each processing stage of the pipeline 400 may include various processing operations performed by, for example, a different processing circuit of the ISP 112 (e.g., where the noise reduction operations of stage 440 are performed by the NR module 212 of the ISP 112, as described above with respect to FIG. 2).

Also, as shown in FIG. 4, the noise map may be received from the image sensor 402 and updated based on processing operations performed at stages of the pipeline 400 that impact pixel noise levels of the input image. Thus, as pixel values of the input image are adjusted based on the operations performed at each of the processing stages 410 and 420, corresponding values of the noise map may be adjusted accordingly. The noise reduction stage 440 of the pipeline 400 may receive the updated noise map directly from stage 420 and use the values of accumulated noise variance in the noise map to locally adjust noise filtration thresholds to reduce spatial and temporal noise while preserving image details. In addition to the filtered image 460, the output of the pipeline 400 may include an aggregated noise map (NM) 465 representing the accumulated noise variance for each pixel of the filtered image 460. In some embodiments, the aggregated noise map 465 may be used to process additional image frames captured by the sensor 402 and processed in the ISP 112.

In some embodiments, the accumulated noise variance (AccVar) per color channel for each pixel may be calculated using Equation (1):

$$Acc {Var}_{ch , x , y} = Acc {Var}_{ch , x , y} \times {gain}_{ch , x , y}^{2} , \qquad ( 1 )$$

where ch is the color channel (e.g., red, green, or blue) and x, y are pixel coordinates. The accumulated noise variance for stages involving convolution operations, such as warping, scaling, and demosaic, which may affect or involve adjusting pixel values across multiple channels, may be calculated using Equation (2):

$$Prev {Var}_{ch , x , y} = {α}^{2} \times Prev {Var}_{ch , x , y} + {( 1 - α )}^{2} \times Acc {Var}_{ch , x , y} + Cov Factor [ SensorGain ] , \qquad ( 2 )$$

where CovFactor is the measured covariance and SensorGain is the gain of the image sensor 402, e.g., as received from the sensor manufacturer/vendor or as measured in a laboratory using relevant flatfield charts. The gain of the image sensor 402 in some implementations may be set to a constant value. In other implementations, the image sensor 402 may have a variable gain, which may be configured based on lighting conditions, e.g., increased gain for higher light sensitivity under dim lighting conditions and decreased for lower sensitivity under bright light or when light intensity exceeds a particular threshold.

In some embodiments, at least one stage of the pipeline 400 may be used to perform image recognition operations for distinguishing different types of content in the scene captured by the input image (e.g., grass versus sky in a nature scene). Such operations may include, for example, object detection, facial recognition, and scene interpretation using one or more machine learning models. In some implementations, the image recognition and interpretation operations may be performed using an AI processing unit (e.g., the AI engine 124 of the processor 104 in FIG. 1, as described above). Values of the noise map and corresponding noise filtration thresholds used in the noise reduction stage 440 may be adjusted for different areas of the input image based on the content of each area. For example, the strength of the noise reduction filter applied to pixels in a first area of the image corresponding to grass or other objects of interest in the nature scene may be decreased to preserve details. Conversely, the strength of the noise reduction filter applied to pixels in a second area of the image corresponding to the sky may be increased, as preserving image details in this area may be unnecessary or less of a priority.

FIG. 5 is a diagram illustrating another example of calibrating noise reduction filter strength using a value map in the form of a gain map that characterizes an accumulated noise variance for each pixel of an input image as a function of gain over different stages of an image processing pipeline 500 of the ISP 112 according to some embodiments of the disclosure. As shown in FIG. 5, the pipeline 500 may include processing stages 510, 520, 530, 540, and 550 for processing an input image captured by an image sensor 502 (e.g., the first image sensor 101 of FIG. 2, as described above), where stage 540 represents the noise reduction stage. Like the noise map used in the pipeline 400 of FIG. 4 described above, the gain map in the pipeline 500 of FIG. 5 may be received with the input image from the image sensor 502 and updated based on the operations performed at one or more stages (e.g., stages 510 and 520) of the processing pipeline 500.

Unlike the noise map in FIG. 4, however, the gain map in FIG. 5 is converted into a noise map at block 535 before being used to perform noise reduction operations at the noise reduction stage 540. In some implementations, the conversion operation of block 535 may be performed as part of the noise reduction stage 540, e.g., as a preliminary step before using the noise map to perform spatial and temporal noise reduction at this stage. The noise reduction stage 540 may use the values of accumulated noise variance in the resulting noise map to locally adjust noise filtration thresholds to reduce spatial and temporal noise in the processed input image. The output of the image processing pipeline 500 may include a filtered image 560 and a corresponding aggregated noise map (NM) 565 representing the accumulated noise variance for each pixel of the filtered image 560.

As operations involving the gain map may be more computationally efficient relative to those involving the noise map, the gain map may be used to reduce the power consumption of the ISP 112 and optimize processing operations performed in early stages of the pipeline 500 before operations affecting pixel values across multiple channels, such as demosaic and color space conversion, are performed in later stages. The gain map therefore provide an optimization option for tracking the accumulated gain during gain operations performed in the early stages of the pipeline 500, which can later be used to calculate the accumulated noise variance used to perform the noise reduction operations at stage 540 for each pixel of the processing input image.

In some embodiments, the accumulated gain (AccGain) per color channel for each pixel may be calculated using Equation (3):

$${AccGain}_{ch , x , y} = {AccGain}_{ch , x , y} \times {gain}_{ch , x , y} , \qquad ( 3 )$$

where ch is the color channel (e.g., red, green, or blue) and x, y are pixel coordinates. The conversion of the gain map into an accumulated noise variance map may be based on Equation (4):

$$Acc {Var}_{ch , x , y} = {AccGain}_{ch , x , y}^{2} \times Var Lut [ SensorGain ] [ \frac{{LocalMeanIntensity}_{ch , x , y}}{{AccGain}_{ch , x , y}} ] , \qquad ( 4 )$$

where SensorGain is the gain of the image sensor 502, and LocalMeanIntensity is the spatially filtered value per channel of each pixel at coordinates x, y. The gain of the image sensor 502 may be constant or variable, like that of the image sensor 402 of FIG. 4 described above.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including receiving an input image frame captured by an image sensor, receiving a value map corresponding to the input image frame, processing the input image frame to determine a processed image frame, wherein the processing comprises determining an updated value map based on the processing of the input image frame, and applying a noise reduction filter to the processed image frame based on the updated value map, wherein a strength of the noise reduction filter applied to each pixel of the input image frame is based on a corresponding value of the updated value map.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the value map comprises a noise map characterizing, for each value in the noise map, an accumulated noise variance for a corresponding pixel of the image sensor.

In a third aspect, in combination with one or more of the first aspect or the second aspect, the noise map characterizes pixel noise levels associated with a first operating mode of the image sensor used to capture the input image frame.

In a fourth aspect, in combination with one or more of the first aspect through the third aspect, the first operating mode is one of a plurality of operating modes associated with the image sensor, and wherein each of the operating modes varies at least one of a resolution, a frame rate, or a gain setting used to capture the input image frame.

In a fifth aspect, in combination with one or more of the first aspect through the fourth aspect, the updated value map comprises a gain map characterizing, for each value in the gain map, an accumulated noise variance as a function of gain for a corresponding pixel of the image sensor.

In a sixth aspect, in combination with one or more of the first aspect through the fifth aspect, the value map is received from the image sensor.

In a seventh aspect, in combination with one or more of the first aspect through the sixth aspect, processing the input image frame includes adjusting pixel values of the input image frame when determining the processed image frame and adjusting corresponding values of the value map according to the adjusted pixel values of the input image frame when determining the processed image frame.

In an eighth aspect, in combination with one or more of the first aspect through the seventh aspect, the input image frame is processed over a plurality of stages, wherein the pixel values are adjusted based on processing operations performed at one or more stages of the plurality of stages, and wherein the corresponding values of the value map are adjusted at each of the one or more stages based on the adjusted pixel values at that stage.

In a ninth aspect, in combination with one or more of the first aspect through the eighth aspect, the processing operations performed at each stage adjust the pixel values in one or more areas of the input image frame, and wherein adjusting the corresponding values of the value map at each stage includes calculating an accumulated variance for each pixel of the one or more areas based on the adjusted pixel values and adjusting the corresponding value of the value map for each pixel based on the accumulated variance calculated for that pixel.

In a tenth aspect, in combination with one or more of the first aspect through the ninth aspect, the plurality of stages includes at least one stage in which image recognition operations are performed to determine a content of a scene in one or more areas of the input image frame, and wherein the corresponding values of the value map are further adjusted based on the content determined for each of the one or more areas.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” “corrected image frame,” and “filtered image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 3 may be combined with one or more blocks (or operations) described with reference to another of the figures. For example, one or more blocks (or operations) of FIG. 3 may be combined with one or more blocks (or operations) of FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving an input image frame captured by an image sensor;
receiving a value map corresponding to the input image frame;
processing the input image frame to determine a processed image frame, wherein the processing comprises determining an updated value map based on the processing of the input image frame; and
applying a noise reduction filter to the processed image frame based on the updated value map, wherein a strength of the noise reduction filter applied to each pixel of the input image frame is based on a corresponding value of the updated value map.

2. The method of claim 1, wherein the value map comprises a noise map characterizing, for each value in the noise map, an accumulated noise variance for a corresponding pixel of the image sensor.

3. The method of claim 2, wherein the noise map characterizes pixel noise levels associated with a first operating mode of the image sensor used to capture the input image frame.

4. The method of claim 3, wherein the first operating mode is one of a plurality of operating modes associated with the image sensor, and wherein each of the operating modes varies at least one of a resolution, a frame rate, or a gain setting used to capture the input image frame.

5. The method of claim 1, wherein the updated value map comprises a gain map characterizing, for each value in the gain map, an accumulated noise variance as a function of gain for a corresponding pixel of the image sensor.

6. The method of claim 1, wherein the value map is received from the image sensor.

7. The method of claim 1, wherein processing the input image frame comprises:
adjusting pixel values of the input image frame when determining the processed image frame; and
adjusting corresponding values of the value map according to the adjusted pixel values of the input image frame when determining the processed image frame.

8. The method of claim 7, wherein the input image frame is processed over a plurality of stages, wherein the pixel values are adjusted based on processing operations performed at one or more stages of the plurality of stages, and wherein the corresponding values of the value map are adjusted at each of the one or more stages based on the adjusted pixel values at that stage.

9. The method of claim 8, wherein the processing operations performed at each stage adjust the pixel values in one or more areas of the input image frame, and wherein adjusting the corresponding values of the value map at each stage comprises:
calculating an accumulated variance for each pixel of the one or more areas based on the adjusted pixel values; and
adjusting the corresponding value of the value map for each pixel based on the accumulated variance calculated for that pixel.

10. The method of claim 8, wherein the plurality of stages includes at least one stage in which image recognition operations are performed to determine a content of a scene in one or more areas of the input image frame, and wherein the corresponding values of the value map are further adjusted based on the content determined for each of the one or more areas.

11. An apparatus, comprising:
a memory storing processor-readable code; and
at least one processor coupled to the memory, the at least one processor configured to execute the processor-readable code to cause the at least one processor to perform operations including:
receiving an input image frame captured by an image sensor;
receiving a value map corresponding to the input image frame;
processing the input image frame to determine a processed image frame, wherein the processing comprises determining an updated value map based on the processing of the input image frame; and
applying a noise reduction filter to the processed image frame based on the updated value map, wherein a strength of the noise reduction filter applied to each pixel of the input image frame is based on a corresponding value of the updated value map.

12. The apparatus of claim 11, wherein the value map comprises a noise map characterizing, for each value in the noise map, an accumulated noise variance for a corresponding pixel of the image sensor.

13. The apparatus of claim 12, wherein the noise map characterizes pixel noise levels associated with a first operating mode of the image sensor used to capture the input image frame.

14. The apparatus of claim 13, wherein the first operating mode is one of a plurality of operating modes associated with the image sensor, and wherein each of the operating modes varies at least one of a resolution, a frame rate, or a gain setting used to capture the input image frame.

15. The apparatus of claim 11, wherein the updated value map comprises a gain map characterizing, for each value in the gain map, an accumulated noise variance as a function of gain for a corresponding pixel of the image sensor.

16. An image capture device, comprising:
an image sensor;
a memory storing processor-readable code; and
at least one processor coupled to the memory and to the image sensor, the at least one processor configured to execute the processor-readable code to cause the at least one processor to:
receiving an input image frame captured by the image sensor;
receiving a value map corresponding to the input image frame;
processing the input image frame to determine a processed image frame, wherein the processing comprises determining an updated value map based on the processing of the input image frame; and
applying a noise reduction filter to the processed image frame based on the updated value map, wherein a strength of the noise reduction filter applied to each pixel of the input image frame is based on a corresponding value of the updated value map.

17. The image capture device of claim 16, wherein the value map comprises a noise map characterizing, for each value in the noise map, an accumulated noise variance for a corresponding pixel of the image sensor.

18. The image capture device of claim 17, wherein the noise map characterizes pixel noise levels associated with a first operating mode of the image sensor used to capture the input image frame.

19. The image capture device of claim 18, wherein the first operating mode is one of a plurality of operating modes associated with the image sensor, and wherein each of the operating modes varies at least one of a resolution, a frame rate, or a gain setting used to capture the input image frame.

20. The image capture device of claim 16, wherein the updated value map comprises a gain map characterizing, for each value in the gain map, an accumulated noise variance as a function of gain for a corresponding pixel of the image sensor.
